(19) United States
(12) Patent Application Publication
(10) Pub. No.: US 2009/0282279 A1
(43) Pub. Date: Nov. 12, 2009

(54) SEMICONDUCTOR INTEGRATED CIRCUIT AND LAYOUT METHOD THEREOF

(76) Inventor: Akihiro Nakamura, Osaka (JP)

Correspondence Address: MCDERMOTT WILL & EMERY LLP, 600 13TH STREET, NW, WASHINGTON, DC, 20005-3096, US

(21) Appl. No.: 12/096,984

(22) PCT Filed: Jul. 25, 2007
(86) PCT No.: PCT/JP2007/064553

§ 371 Date: Jun. 11, 2008

(30) Foreign Application Priority Data
Nov. 10, 2006 (JP) 2006-305495

(51) Int. Cl. G06F 1/04

(52) U.S. Cl. 713/400

(57) ABSTRACT

An internal circuit (151) has a timing constraint only in relation to an internal-signal transmitting and receiving circuit (102) and no timing constraint in relation to an external-signal receiving circuit (101). A layout accordingly becomes possible in which the external-signal receiving circuit (101) is not affected by the timing constraint of the internal circuit (151). Since a layout of the external-signal receiving circuit (101) thus realizes shorter distances between the external-signal receiving circuit (101) and the external clock terminal (154) and between the external-signal receiving circuit (101) and the external data terminal (155) so as to satisfy the timing constraints between the external-signal receiving circuit (101) and the external clock and data terminals (155) and (154), the timing constraint between an AC clock signal and an AC data signal is easily satisfied.

### TECHNICAL FIELD

The present invention relates to a semiconductor integrated circuit including a circuit for externally inputting an AC clock signal and an AC data signal and a layout method of the semiconductor integrated circuit, and particularly to a technique for easily satisfying a timing constraint generated between an AC clock signal and an AC data signal.

### BACKGROUND ART

In a semiconductor integrated circuit, a clock signal and a data signal are inputted from outside of the semiconductor integrated circuit and the externally inputted data signal is processed in the semiconductor integrated circuit in synchronization with the externally inputted clock signal or a clock signal generated inside the semiconductor integrated circuit. Accordingly, a semiconductor integrated circuit has a circuit for inputting a clock signal and a data signal from outside of the semiconductor integrated circuit.

FIG. 8 is a block diagram of a conventional semiconductor integrated circuit having a circuit for inputting a clock signal and a data signal from outside of the semiconductor integrated circuit. In FIG. 8, the element 11 is an external-signal receiving circuit, 51 is an internal circuit, 52 is an AC clock signal wiring, 53 is an AC data signal wiring, 54 is an external clock terminal, 55 is an external data terminal, 56 is an internal circuit transmission data signal wiring, and 57 is an internal circuit receiving data signal wiring.

The AC data signal wiring 53 is to transmit an AC data signal inputted from the external data terminal 55 to the external-signal receiving circuit 11.

The AC clock signal wiring 52 is to transmit an AC clock signal inputted from the external clock terminal 54 to the external-signal receiving circuit 11.

The internal circuit transmission data signal wiring 56 is to transmit an internal signal generated in the internal circuit 51 to the external-signal receiving circuit 11.

The internal circuit receiving data signal wiring 57 is to transmit an output signal of the external-signal receiving circuit 11 to the internal circuit 51.

The external-signal receiving circuit 11 processes the AC data signal transmitted via the AC data signal wiring 53 and the internal signal transmitted via the internal circuit transmission data signal wiring 56 in synchronization with the AC clock signal transmitted via the AC clock signal wiring 52 to transmit the output signal to the internal circuit 51.

Such circuit structure in which the AC data signal is processed in synchronization with the AC clock signal causes a timing constraint that does not allow the difference between the timing of the AC data signal to be inputted from outside of the semiconductor integrated circuit and the timing of the AC clock signal to be inputted from outside of the semiconductor integrated circuit to be greater than a certain interval.

To satisfy this constraint, a semiconductor integrated circuit has to be laid out so as to make the difference between the delay time of the AC data signal wiring 53 where the AC data signal passes through and the delay time of the AC clock signal wiring 52 where the AC clock signal passes through to fall within a certain range.

In recent years however, semiconductor integrated circuits were advanced in miniaturization and acceleration. AC clock signals accordingly have higher frequencies, and thus the allowance for a timing error between an AC clock signal and an AC data signal became smaller. The AC clock signal wiring 52 and the AC data signal wiring 53 had increasing variation in the delay time due to deterioration in signal quality during production or because of the power noise, for example. Such increase in the variation became a factor of an increased number of steps and more difficulty for layout of a semiconductor integrated circuit that satisfies the allowance for a timing error between an AC clock signal and an AC data signal.

A conventional semiconductor integrated circuit accordingly employed a layout that has shorter distances between the external-signal receiving circuit 11 and the external data terminal 55 and between the external-signal receiving circuit 11 and the external clock terminal 54 to reduce the delay time of the AC data signal wiring 53 and the delay time of the AC clock signal wiring 52, and thus the timing constraint between an AC clock signal and an AC data signal were easily satisfied (refer to Patent Document 1, for example).

Patent Document 1: JP 2001-67864 A (page 3)

### DISCLOSURE OF INVENTION

### Problems to be Solved by the Invention

The external-signal receiving circuit 11, however, has to satisfy the timing constraint in relation to the internal circuit 51 to transmit and receive a data signal to and from the internal circuit 51. Accordingly, the external-signal receiving circuit 11 has to be laid out at a position that satisfies both the timing constraint in relation to the internal circuit 51 and the timing constraint between an AC clock signal and an AC data signal.

The external-signal receiving circuit 11 is thus affected by the timing constraint in relation to the internal circuit 51 and cannot be disposed in the layout that has shorter distances between the external-signal receiving circuit 11 and the external data terminal 55 and between the external-signal receiving circuit 11 and the external clock terminal 54. Such external-signal receiving circuit 11 thus causes a problem in which the number of steps does not decrease and the degree of difficulty is not moderated, both for layout of a semiconductor integrated circuit, to satisfy the timing constraint between an AC clock signal and an AC data signal.

The present invention was made by addressing such problem, and an object of the present invention is to provide a semiconductor integrated circuit, easily satisfying the timing constraint between an AC clock signal and an AC data signal without affected by the timing constraint in relation to an internal circuit, and a layout method thereof.

### Means for Solving the Problems

In order to solve this problem, a semiconductor integrated circuit according to the present invention is a semiconductor integrated circuit including a circuit to which an AC clock signal and an AC data signal are externally inputted, the semiconductor integrated circuit includes: an external-signal receiving circuit for receiving the AC data signal inputted from outside of the semiconductor integrated circuit; an internal-signal transmitting and receiving circuit for receiving a signal generated in an internal circuit of the semiconductor integrated circuit and/or transmitting a signal to the internal circuit; a data signal wiring for transmitting an output signal of the external-signal receiving circuit to the input signal of the internal-signal transmitting and receiving circuit; and an AC clock signal wiring for providing the AC clock signal inputted from outside of the semiconductor integrated circuit for the external-signal receiving circuit and the internal-signal transmitting and receiving circuit.

In the semiconductor integrated circuit, the external-signal receiving circuit includes an external-signal receiving flip flop for receiving the AC data signal inputted from outside of the semiconductor integrated circuit, the external-signal receiving flip flop latches the AC data signal and transmits the latched signal via the data signal wiring to the internal-signal transmitting and receiving circuit, and the AC clock signal inputted from outside of the semiconductor integrated circuit is provided via the AC clock signal wiring for the external-signal receiving flip flop.

In the semiconductor integrated circuit, the internal-signal transmitting and receiving circuit includes an internal-signal transmitting and receiving flip flop for receiving the output signal of the external-signal receiving circuit transmitted via the data signal wiring, and the AC clock signal inputted from outside of the semiconductor integrated circuit is provided for the internal-signal transmitting and receiving flip flop via the AC clock signal wiring.

In the semiconductor integrated circuit, the external-signal receiving circuit includes a plurality of the external signal receiving flip flops or the internal-signal transmitting and receiving circuit includes a plurality of the internal-signal transmitting and receiving flip flops, and the semiconductor integrated circuit includes a plurality of the data signal wirings.

The semiconductor integrated circuit further includes a circuit or a circuit element which operates in synchronization with a clock signal instead of the external-signal receiving flip flop or the internal-signal transmitting and receiving flip flop.

In the semiconductor integrated circuit, a clock latency of the AC clock signal wiring connected to the external-signal receiving circuit is shorter than a clock latency of the AC clock signal wiring connected to the internal-signal transmitting and receiving circuit.

In the semiconductor integrated circuit, a timing relaxation circuit is interposed in the data signal wiring connecting the output signal of the external-signal receiving circuit and the input signal of the internal-signal transmitting and receiving circuit.

In the semiconductor integrated circuit, the timing relaxation circuit is any of a delay buffer, an inversion latch, and an inversion flip flop which cause a timing delay.

The semiconductor integrated circuit further includes an external-signal receiving clock selector and an internal-signal transmitting and receiving clock selector capable of selecting any one of a plurality of the AC clock signals. In the semiconductor integrated circuit, an output signal of the external-signal receiving clock selector is inputted to the external-signal receiving circuit, and an output signal of the internal-signal transmitting and receiving clock selector is inputted to the internal-signal transmitting and receiving circuit.

In the semiconductor integrated circuit, the external-signal receiving clock selector has a function of selecting any one clock signal from an internal clock signal generated inside of the semiconductor integrated circuit and the plurality of AC clock signals to provide for the external-signal receiving circuit, and the internal-signal transmitting and receiving clock selector has a function of selecting any one clock signal from the internal clock signal and the plurality of AC clock signals to provide for the internal-signal transmitting and receiving circuit.

The semiconductor integrated circuit further includes: a plurality of the external-signal receiving circuits; and an external-signal reception selecting circuit capable of selecting any output signal of the plurality of external-signal receiving circuits. In the semiconductor integrated circuit, the output signals of the external-signal reception selecting circuits are inputted to the internal-signal transmitting and receiving circuit.

A layout method of the semiconductor integrated circuit according to the present invention includes: an external-signal receiving circuit disposition step for disposing the external-signal receiving circuit in a vicinity of an external data terminal or an external clock terminal of the semiconductor integrated circuit; an internal-signal transmitting and receiving circuit disposition step for disposing the internal-signal transmitting and receiving circuit at an arbitrary position of the semiconductor integrated circuit; an external-signal receiving clock circuit disposition step for disposing and wiring the AC clock signal wiring and/or the external-signal receiving clock selector connected between the external clock terminal and the external-signal receiving circuit in the vicinity of the external clock terminal; and an internal-signal transmitting and receiving clock circuit disposition step for disposing and wiring the AC clock signal wiring and/or the internal-signal transmitting and receiving clock selector connected between the external clock terminal and the internal-signal transmitting and receiving circuit.

### EFFECTS OF THE INVENTION

According to the present invention, a layout is realized that has shorter distances between an external-signal receiving circuit and an external data terminal and between an external-signal receiving circuit and an external clock terminal for easy satisfaction of the timing constraint between an AC clock signal and an AC data signal.

### BRIEF DESCRIPTION OF DRAWINGS

FIG. 1 is a block diagram of a semiconductor integrated circuit according to the first embodiment of the present invention.

FIG. 2 is a block diagram of a semiconductor integrated circuit according to the second embodiment of the present invention.

FIG. 3 is a block diagram of a semiconductor integrated circuit according to the third embodiment of the present invention.

FIG. 4 is a timing diagram of the semiconductor integrated circuit according to the third embodiment of the present invention.

FIG. 5 is a block diagram of a semiconductor integrated circuit according to the fourth embodiment of the present invention.

FIG. 6 is a block diagram of a semiconductor integrated circuit of the fifth embodiment of the present invention.

FIG. 7 is a flow chart of a layout method of a semiconductor integrated circuit according to the sixth embodiment of the present invention.

FIG. 8 is a block diagram of a conventional semiconductor integrated circuit.

### DESCRIPTION OF REFERENCE NUMERALS

11 External-Signal Receiving Circuit
51 Internal Circuit
52 AC Clock Signal Wiring
53 AC Data Signal Wiring
54 External Clock Terminal
55 External Data Terminal
56 Internal Circuit Transmission Data Signal Wiring
57 Internal Circuit Receiving Data Signal Wiring
101 External-Signal Receiving Circuit
102 Internal-Signal Transmitting and Receiving Circuit
103 Data Signal Wiring
104 External-Signal Receiving Flip Flop
105 Internal-Signal Transmitting and Receiving Flip Flop
151 Internal Circuit
152 AC Clock Signal Wiring
153 AC Data Signal Wiring
154 External Clock Terminal
155 External Data Terminal
156 Internal Circuit Transmission Data Signal Wiring
157 Internal Circuit Receiving Data Signal Wiring
201 Clock Tree
301 Timing Relaxation Circuit
302 Inversion Flip Flop
501 External-Signal Receiving Clock Selector
502 Internal-Signal Transmitting and Receiving Clock Selector
503 Internal Clock Generation Circuit
601 First External-Signal Receiving Circuit
602 Second External-Signal Receiving Circuit
603 External-Signal Reception Selecting Circuit
604 First External-Signal Receiving Clock Selector
605 Second External-Signal Receiving Clock Selector
606 First External Data Terminal
607 Second External Data Terminal
608 First External Clock Terminal
609 Second External Clock Terminal
701 External-Signal Receiving Circuit Disposition Step
702 Internal-Signal Transmitting and Receiving Circuit Disposition Step
703 External-Signal Receiving Clock Circuit Disposition Step
704 Internal-Signal Transmitting and Receiving Clock Circuit Disposition Step

### BEST MODE FOR CARRYING OUT THE INVENTION

Hereinafter, embodiments of the present invention are illustrated with reference to the drawings.

### First Embodiment

FIG. 1 shows a block diagram of a semiconductor integrated circuit according to the first embodiment of the present invention. In FIG. 1, the element 101 is an external-signal receiving circuit, 102 is an internal-signal transmitting and receiving circuit, 103 is a data signal wiring, 104 is an external-signal receiving flip flop, 105 is an internal-signal transmitting and receiving flip flop, 151 is an internal circuit, 152 is an AC clock signal wiring, 153 is an AC data signal wiring, 154 is an external clock terminal, 155 is an external data terminal, 156 is an internal circuit transmission data signal wiring, and 157 is an internal circuit receiving data signal wiring.

The external-signal receiving circuit 101 is structured to receive an AC data signal inputted from the external data terminal 155 via the AC data signal wiring 153, latch the AC data signal in the external-signal receiving flip flop 104 in synchronization with an AC clock signal inputted from the external clock terminal 154, and transmit the received AC data signal to the data signal wiring 103.

The internal-signal transmitting and receiving circuit 102 is structured to receive the AC data signal transmitted from the external-signal receiving circuit 101 and an output signal of the internal signal generation circuit 151 via the data signal wiring 103 and the internal circuit transmission data signal wiring 156, latch the two signals in the internal-signal transmitting and receiving flip flop 105 in synchronization with the AC clock signal, and transmit the received data to the internal circuit receiving data signal wiring 157.

The internal circuit 151 is structured to receive the data transmitted from the internal-signal transmitting and receiving circuit 102 and transmit the data to the internal-signal transmitting and receiving circuit 102 in synchronization with an AC clock signal.

The AC clock signal wiring 152 is structured to provide the AC clock signal inputted from the external clock terminal 154 for the external-signal receiving circuit 101, the internal-signal transmitting and receiving circuit 102, and the internal circuit 151.

The description below describes an operation of the semiconductor integrated circuit structured as shown in FIG. 1.

An AC data signal inputted from the external data terminal 155 is transmitted via the AC data signal wiring 153, and an AC clock signal inputted from the external clock terminal 154 is transmitted via the AC clock signal wiring 152, both to the external-signal receiving circuit 101. The AC data signal is latched in the external-signal receiving flip flop 104 in synchronization with the AC clock signal. The external-signal receiving circuit 101 is accordingly affected by the timing constraint between the AC clock signal and the AC data signal.

The AC data signal latched in the external-signal receiving circuit 101 in synchronization with the AC clock signal is transmitted to the internal-signal transmitting and receiving circuit 102 to be latched in synchronization with the AC clock signal. Accordingly, a timing constraint is generated between the external-signal receiving circuit 101 and the internal-signal transmitting and receiving circuit 102.

The AC data signal latched in the internal-signal transmitting and receiving circuit 102 in synchronization with the AC clock signal is transmitted to the internal circuit 151 to be latched in synchronization with the AC clock signal. A signal generated in the internal circuit 151 in synchronization with the AC clock signal is transmitted to the internal-signal transmitting and receiving circuit 102 to be latched in synchronization with the AC clock signal. Accordingly, a timing constraint is generated between the internal-signal transmitting and receiving circuit 102 and the internal circuit 151.

As described above, a semiconductor integrated circuit structured as shown in FIG. 1 has three timing constraints in total: a timing constraint between the external-signal receiving circuit 101 and the external clock or data terminal 154 or 155, a timing constraint between the external-signal receiving circuit 101 and the internal-signal transmitting and receiving circuit 102, and a timing constraint between the internal-signal transmitting and receiving circuit 102 and the internal circuit 151.

The timing constraint is, however, generated with the internal circuit 151 only in relation to the internal-signal transmitting and receiving circuit 102, and no timing constraint is generated in relation to the external-signal receiving circuit 101. The external-signal receiving circuit 101 is thus disposed in a layout without affected by the timing constraint of the internal circuit 151.

A layout of the external-signal receiving circuit 101, therefore, becomes possible that has shorter distances between the external-signal receiving circuit 101 and the external clock terminal 154 and between the external-signal receiving circuit 101 and the external data terminal 155 to satisfy the timing constraint between the external-signal receiving circuit 101 and the external clock or data terminal 154 or 155.

Although in this embodiment described is the structure in which the external-signal receiving circuit 101 employs the external-signal receiving flip flop 104 and the internal-signal transmitting and receiving circuit 102 employs the internal-signal transmitting and receiving flip flop 105, it should be noted that the equivalent effect is also obtained in a case that the external-signal receiving circuit 101 or the internal-signal transmitting and receiving circuit 102 employ a circuit or a circuit element operated in synchronization with AC clock signals, such as an SRAM.

Although in this embodiment described is the case that both the internal circuit transmission data signal wiring 156 and the internal circuit receiving data signal wiring 157 are disposed between the internal-signal transmitting and receiving circuit 102 and the internal circuit 151, an equivalent effect is also obtained in a case that only either the internal circuit transmission data signal wiring 156 or the internal circuit receiving data signal wiring 157 is disposed.

An equivalent effect is also obtained in a case of a structure in which not only each one but each plurality of AC data signal wirings 153, data signal wirings 103, internal circuit transmission data signal wirings 156, and internal circuit receiving data signal wirings 157 is disposed and each plurality of external-signal receiving flip flops 104 and internal-signal transmitting and receiving flip flops 105 is disposed for an operation in the external-signal receiving circuit 101, the internal-signal transmitting and receiving circuit 102, and the internal circuit 151, in synchronization with the AC clock signal.

### Second Embodiment

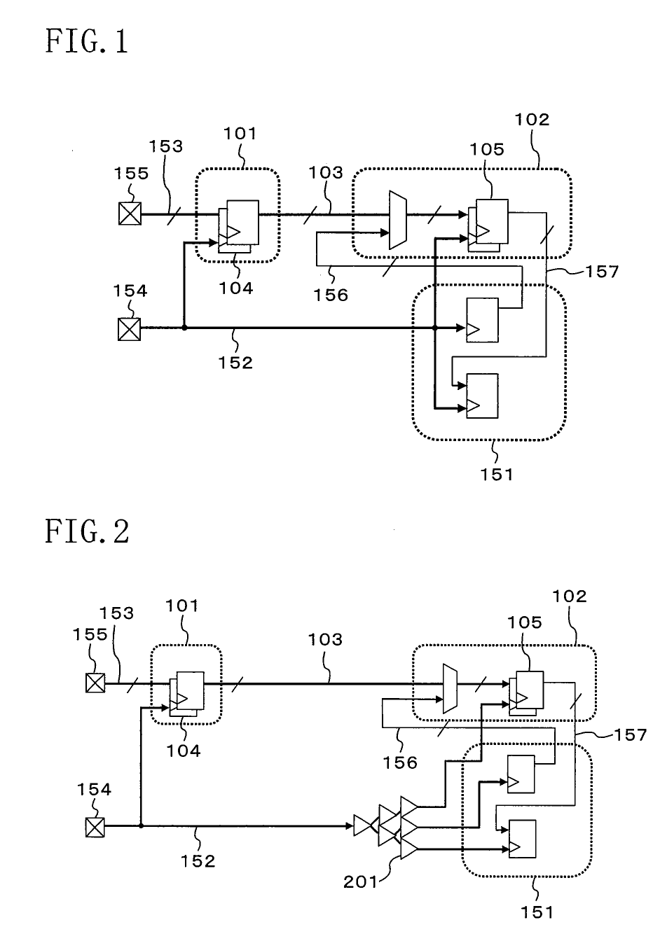

FIG. 2 shows a block diagram of a semiconductor integrated circuit according to the second embodiment of the present invention. In FIG. 2, the element 201 is a clock tree. The difference from FIG. 1 is that the clock tree 201 is interposed in the AC clock signal wiring 152 disposed between the external clock terminal 154 and the internal-signal transmitting and receiving circuit 102 and between the external clock terminal 154 and the internal circuit 151.

The description below describes an operation of a semiconductor integrated circuit structured as shown in FIG. 2.

An AC clock signal inputted from the external clock terminal 154 is delayed in the clock tree 201 and inputted to the internal-signal transmitting and receiving circuit 102 and the internal circuit 151. The clock latency of the AC clock signal wiring 152 to be inputted to the external-signal receiving circuit 101 is accordingly shorter than the clock latency of the AC clock signal wiring 152 to be inputted to the internal-signal transmitting and receiving circuit 102 and the internal circuit 151. The timing of the AC clock signal to be inputted to the internal-signal transmitting and receiving circuit 102 and the internal circuit 151 is delayed more than the timing of the AC clock signal to be inputted to the external-signal receiving circuit 101.

A layout of a general semiconductor integrated circuit employs a method that interposes the clock tree 201 into a clock wiring in order to equalize the clock latencies of the clock signals inputted to the synchronous circuits and avoid wave rounding in a clock signal. Such method is prone to increase the signal delay time in the clock tree 201 with an increased number of synchronous circuits for which the clock signal is provided.

In contrast, the semiconductor integrated circuit structured as shown in FIG. 2 does not have a clock tree 201 interposed in relation to the external-signal receiving circuit 101. The clock latency of the AC clock signal wiring 152 inputted to the external-signal receiving circuit 101 is, accordingly, not affected by the increased signal delay time of the clock tree 201 due to the increased number of synchronous circuits included in the internal-signal transmitting and receiving circuit 102 and the internal circuit 151. Even in the case of the increased number of synchronous circuits included in the internal-signal transmitting and receiving circuit 102 and the internal circuit 151, a layout becomes possible that reduces the delay time of the AC clock signal wiring 152, and thus such semiconductor integrated circuit has an effect of easily satisfying the timing constraint between an AC clock signal and an AC data signal.

Although in this embodiment described is the case of the clock tree 201 interposed in the AC clock signal wiring 152 disposed between the external clock terminal 154 and the internal circuit 151, it should be noted that an equivalent effect is also obtained by a unit having an element or a circuit structure that realizes a time delay in a signal, such as a buffer and a delay circuit, instead of the clock tree 201.

In a case that the clock tree 201 is not used, an equivalent effect is also obtained as long as a semiconductor integrated circuit includes a wiring structure in such a way that the clock latency of the AC clock signal wiring 152 inputted to the external-signal receiving circuit 101 is shorter than the clock latency of the AC clock signal wiring 152 inputted to the internal-signal transmitting and receiving circuit 102 and the internal circuit 151.

### Third Embodiment

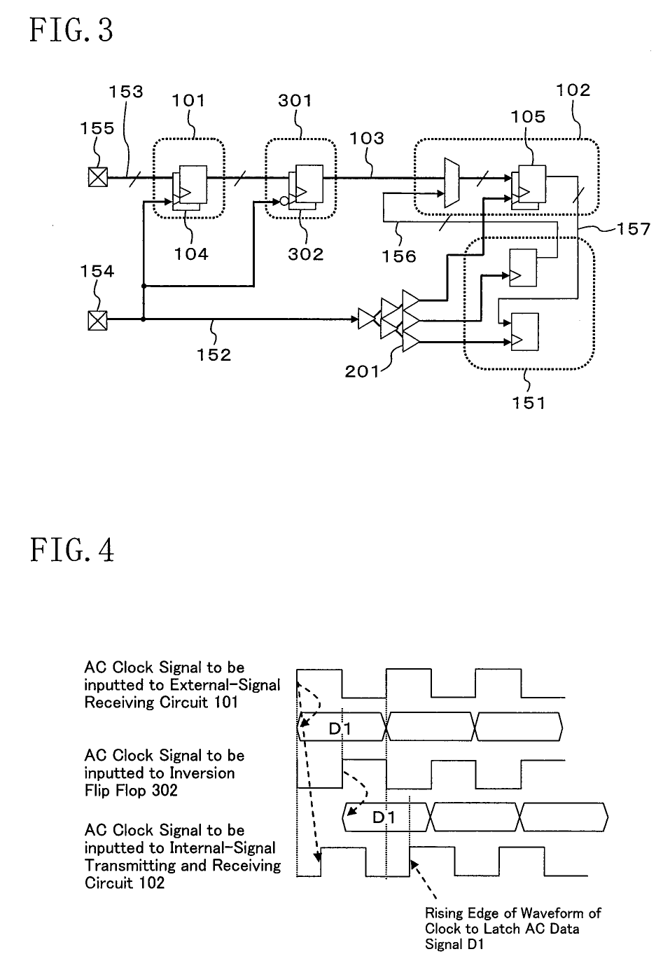

FIG. 3 shows a block diagram of a semiconductor integrated circuit according to the third embodiment of the present invention. In FIG. 3, the element 301 is a timing relaxation circuit and 302 is an inversion flip flop.

The difference from FIG. 2 is that the timing relaxation circuit 301 is interposed in the data signal wiring 103. The timing relaxation circuit 301 is structured in such a way that the signal transmitted from the external-signal receiving circuit 101 is latched in the inversion flip flop 302 in synchronization with the inversion signal of the AC clock signal to transmit the signal to the internal-signal transmitting and receiving circuit 102.

The clock latency from the external clock terminal 154 to the timing relaxation circuit 301 is equivalent to, or negligibly different from, the clock latency from the external clock terminal 154 to the external-signal receiving circuit 101.

The description below describes an operation of the semiconductor integrated circuit structured as shown in FIG. 3.

The AC data signal transmitted from the external-signal receiving circuit 101 in synchronization with the AC clock signal is latched in the inversion flip flop 302 in synchronization with the inversion signal of the AC clock signal to be transmitted to the internal-signal transmitting and receiving circuit 102. The AC data signal transmitted to the internal-signal transmitting and receiving circuit 102 is latched in the internal-signal transmitting and receiving flip flop 105 in synchronization with the AC clock signal delayed by the clock tree 201.

FIG. 4 shows a timing diagram of the semiconductor integrated circuit structured as FIG. 3.

On a rising edge of the waveform of the AC clock signal inputted to the external-signal receiving circuit 101, AC data signal D1 is transmitted to be held until the next rising edge of the waveform of the AC clock signal. The circuit connected at the next stage of the external-signal receiving circuit 101 has to latch AC data signal D1 on the rising edge immediately subsequent to the rising edge of the waveform of the AC clock signal on which AC data signal D1 has been transmitted.

Should the next stage of the external-signal receiving circuit 101 be the internal-signal transmitting and receiving circuit 102 as shown in the block diagram of the semiconductor integrated circuit in FIG. 2, the clock latency of the AC clock signal responding to the external-signal receiving circuit 101 would be shorter than the clock latency responding to the internal-signal transmitting and receiving circuit 102 so that the timing of the AC clock signal inputted to the internal-signal transmitting and receiving circuit 102 would be delayed more than the timing of the AC clock signal inputted to the external-signal receiving circuit 101. The internal-signal transmitting and receiving circuit 102 accordingly would not be able to latch AC data signal D1 on the rising edge immediately subsequent to the rising edge of the waveform of the AC clock signal on which AC data signal D1 would have been transmitted.

In contrast, in the semiconductor integrated circuit structured as shown in FIG. 3, AC data signal D1 outputted from the external-signal receiving circuit 101 is latched once with the inversion signal of the AC clock signal in the timing relaxation circuit 301 so that AC data signal D1 is delayed by a half cycle of the AC clock signal. This signal delay compensates for the timing deterioration due to the AC clock signal delay in the clock tree 201. It, therefore, becomes possible for the internal-signal transmitting and receiving circuit 102 to latch AC data signal D1 on the rising edge immediately subsequent to the rising edge of the waveform of the AC clock signal on which AC data signal D1 has been transmitted.

Although in this embodiment described is the case that the inversion flip flop 302 is employed for the timing relaxation circuit 301, it should be noted that an equivalent effect is also obtained as long as the semiconductor integrated circuit includes a unit having an element or a circuit structure realizing a time delay of a signal, such as an inversion latch, a buffer, and a delay circuit, instead of the inversion flip flop 302.

### Fourth Embodiment

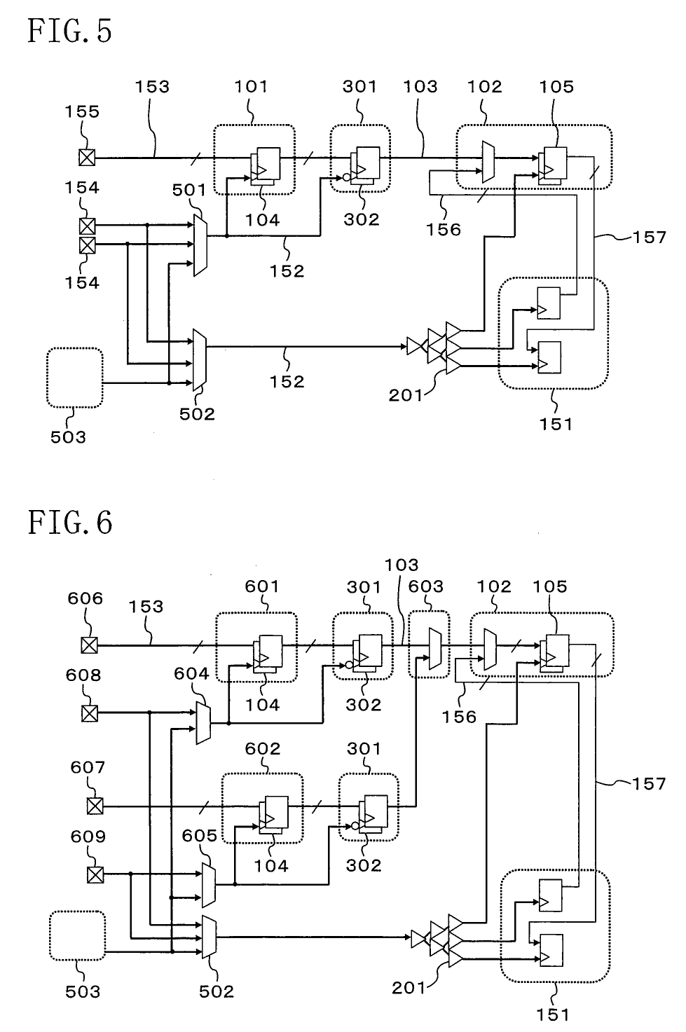

FIG. 5 shows a block diagram of a semiconductor integrated circuit according to the fourth embodiment of the present invention. In FIG. 5, the element 501 is an external-signal receiving clock selector, 502 is an internal-signal transmitting and receiving clock selector, and 503 is an internal clock generation circuit.

The difference from FIG. 3 is that the semiconductor integrated circuit includes a plurality of external clock terminals 154, and the AC clock signals inputted from the plurality of external clock terminals 154 and an internal clock signal outputted from an internal clock generation circuit 503 are inputted to an external-signal receiving clock selector 501 and an internal-signal transmitting and receiving clock selector 502. The output signal of the external-signal receiving clock selector 501 is inputted to the external-signal receiving circuit 101, and the internal-signal transmitting and receiving clock selector 502 is inputted to the internal-signal transmitting and receiving circuit 102 and the internal circuit 151.

The description below describes an operation of the semiconductor integrated circuit structured as shown in FIG. 5.

The external-signal receiving clock selector 501 and the internal-signal transmitting and receiving clock selector 502 select any of the inputted output signals from the internal clock generation circuit 503 and the plurality of external clock terminals 154. The input clock signal selected by the external-signal receiving clock selector 501 is defined the same as the input clock signal selected by the internal-signal transmitting and receiving clock selector 502. For example, in a case that the external-signal receiving clock selector 501 selects one of the AC clock signals, the internal-signal transmitting and receiving clock selector 502 also selects the same AC clock signal.

Such configuration transmits the input clock signal selected by the external-signal receiving clock selector 501 and the internal-signal transmitting and receiving clock selector 502 to all of the external-signal receiving circuit 101, the internal-signal transmitting and receiving circuit 102, and the internal circuit 151. Even in a case that the plurality of AC clock signals are inputted from the plurality of external clock terminals 154, a layout thus becomes possible that reduce the delay time of the AC clock signal wiring 152 connected from the external clock terminals 154 to the external-signal receiving circuit 101, and this embodiment is effective for easy satisfaction of the timing constraint between an AC clock signal and an AC data signal.

Although this embodiment described the case that the AC clock signals inputted from the plurality of external clock terminals 154 and the internal clock signal outputted from the internal clock generation circuit 503 are inputted to the external-signal receiving clock selector 501 and the internal-signal transmitting and receiving clock selector 502, it should be noted that an equivalent effect is also obtained in a case only the AC clock signals inputted from the plurality of external clock terminals 154 are inputted to the external-signal receiving clock selector 501 and the internal-signal transmitting and receiving clock selector 502.

### Fifth Embodiment

FIG. 6 shows a block diagram of a semiconductor integrated circuit according to the fifth embodiment of the present invention. In FIG. 6, the element 601 is a first external-signal receiving circuit, 602 is a second external-signal receiving circuit, 603 is an external-signal reception selecting circuit, 604 is a first external-signal receiving clock selector, 605 is a second external-signal receiving clock selector, 606 is a first external data terminal 607 is a second external data terminal, 608 is a first external clock terminal, and 609 is a second external clock terminal.

This semiconductor integrated circuit is structured in such a way that an output signal of the first external-signal receiving circuit 601 and an output signal of the second external-signal receiving circuit 602 are inputted via the timing relaxation circuit 301 to the external-signal reception selecting circuit 603, and an output signal of the external-signal reception selecting circuit 603 is inputted to the internal-signal transmitting and receiving circuit 102.

The difference from FIG. 5 is that the structure shown in FIG. 6 has each pair of elements equivalent for the external-signal receiving circuit 101, the external clock terminals 154, the external data terminal 155, and the external-signal receiving clock selector 501 in FIG. 5, which are respectively the first and second external-signal receiving circuits 601 and 602, the first and second external clock terminals 608 and 609, the first and second external data terminals 606 and 607, and the first and the second external-signal receiving clock selectors 604 and 605, and that either one of the output signals of the first and second external-signal receiving circuits 601 and 602 is inputted to the internal-signal transmitting and receiving circuit 102.

The description below describes an operation of the semiconductor integrated circuit structured as shown in FIG. 6.

The first external-signal receiving clock selector 604, the second external-signal receiving clock selector 605, and the internal-signal transmitting and receiving clock selector 502 select either the output signal of the internal clock generation circuit 503 or the AC clock signal inputted from the first or second external clock terminal 608 or 609.

The input clock signal selected by the first or second external-signal receiving clock selector 604 or 605 is defined the same as the input clock signal selected by the internal-signal transmitting and receiving clock selector 502. For example, in a case that the first external-signal receiving clock selector 604 selects the AC clock signal inputted from the first external clock terminal 608, the internal-signal transmitting and receiving clock selector 502 also selects the same AC clock signal.

Such structure enables the input clock signal selected by the first or second external-signal receiving clock selector 604 or 605 to be transmitted to all of the internal-signal transmitting and receiving circuit 102, the internal circuit 151, and the first or second external-signal receiving circuit 601 or 602.

The AC clock signal inputted from the first external clock terminal 608 is inputted via the first external-signal receiving clock selector 604 to the first external-signal receiving circuit 601, and the AC clock signal inputted from the second external clock terminal 609 is inputted via the second external-signal receiving clock selector 605 to the second external-signal receiving circuit 602.

A layout thus becomes possible that reduces the delay time of the AC clock signal wiring 152 connected from the first external clock terminal 608 to the first external-signal receiving circuit 601 and reduces the delay time of the AC data signal 153 connected from the first external data terminal 606 to the first external-signal receiving circuit 601 so that the timing constraint, for the first external clock terminal 608 and the first external data terminal 606, between an AC clock signal and an AC data signal is easily satisfied. A layout also becomes possible that reduces the delay time of the AC clock signal wiring 152 connected from the second external clock terminal 609 to the second external-signal receiving circuit 602 and reduces the delay time of the AC data signal 153 connected from the second external data terminal 607 to the second external-signal receiving circuit 602 so that the timing constraint, for the second external clock terminal 609 and the second external data terminal 607, between an AC clock signal and an AC data signal is easily satisfied.

Even in a case that the first external clock terminal 608 or the first external data terminal 606 is disposed at a position physically distant from the second external clock terminal 609 or the second external data terminal 607, a layout therefore becomes possible that has a shorter AC clock signal wiring 152 and a shorter AC data signal 153 respectively, and the semiconductor integrated circuit has an effect that easily satisfies the timing constraint between an AC clock signal and an AC data signal.

Although in this embodiment described is the case that each of the elements consisting of two components, which are the external-signal receiving circuits 601 and 602, the external clock terminals 608 and 609, the external data terminals 606 and 607, and the external-signal receiving clock selectors 604 and 605, it should be noted that an equivalent effect is also realized in a case that each elements consisting of three or more components.

### Sixth Embodiment

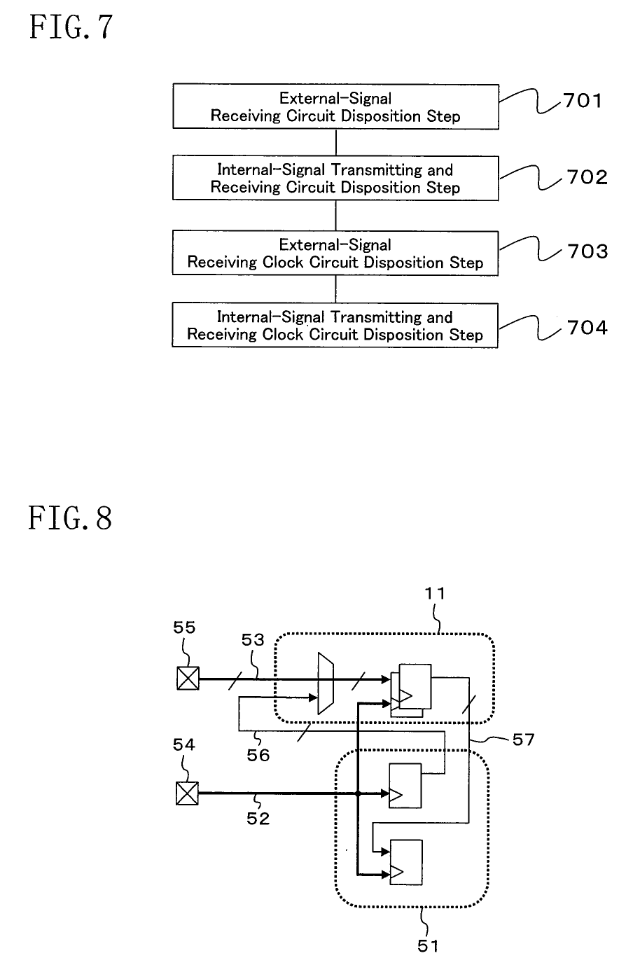

FIG. 7 shows a flow chart of a layout method of the semiconductor integrated circuit according to the sixth embodiment of the present invention. In FIG. 7, the element 701 is an external-signal receiving circuit disposition step, 702 is an internal-signal transmitting and receiving circuit disposition step, 703 is an external-signal receiving clock circuit disposition step, and 704 is an internal-signal transmitting and receiving clock circuit disposition step.

Each process of the flow chart of the layout method of the semiconductor integrated circuit shown in FIG. 7 is described with an example of the semiconductor integrated circuit structured as shown in FIG. 6.

First, in the external-signal receiving circuit disposition step 701, the first and second external-signal receiving circuits 601 and 602 are disposed in the vicinity of the first and second external data terminals 606 and 607 and the vicinity of the first and second external clock terminals 608 and 609, respectively. A layout is thus realized that reduces the delay time of the AC data signal.

Next, in the internal-signal transmitting and receiving circuit disposition step 702, the internal-signal transmitting and receiving circuit 102, the internal circuit 151, the timing relaxation circuit 301, and the external-signal reception selecting circuit 603 are disposed at arbitrary positions of the semiconductor integrated circuit to satisfy the timing constraints between the internal-signal transmitting and receiving circuit 102 and the first or second external-signal receiving circuit 601 or 602 and between the internal-signal transmitting and receiving circuit 102 and the internal circuit 151. It is possible to dispose these circuits without affected by the timing constraints between AC clock signals and AC data signals inputted from the first and second external data terminals 606 and 607, and the first and second external clock terminals 608 and 609.

Then, in the external-signal receiving clock circuit disposition step 703, the AC clock signal wiring 152 connected between the first external clock terminal 608 and the first external-signal receiving circuit 601 and the first external-signal receiving clock selector 604 are disposed in the vicinity of the first external clock terminal 608, and the AC clock signal wiring 152 connected between the second external clock terminal 609 and the second external-signal receiving circuit 602 and the second external-signal receiving clock selector 605 are disposed in the vicinity of the second external clock terminal 609. A layout is thus realized to reduce the delay times of the AC clock signals connected to the first and second external-signal receiving circuit 601 and 602.

Lastly, in the internal-signal transmitting and receiving clock circuit disposition step 704, the AC clock signal wirings 152 connected from the first and second external clock terminals 608 and 609 to the internal-signal transmitting and receiving circuit 102 and the internal circuit 151, the internal-signal transmitting and receiving clock selector 502, and the clock tree 201 are wired or disposed. It is possible to dispose these circuits without affected by the timing constraints between AC clock signals and AC data signals inputted from the first and second external data terminals 606 and 607 and the first and second external clock terminals 608 and 609.

As described above, in this embodiment, the external-signal receiving circuit disposition step 701 and the external-signal receiving clock circuit disposition step 703 include disposition of elements to satisfy the timing constraints generated in the courses from the first and second external clock terminals 608 and 609 and the first and second external data terminals 606 and 607 to the first and second external-signal receiving circuits 601 and 602. The internal-signal transmitting and receiving circuit disposition step 702 and the internal-signal transmitting and receiving clock circuit disposition step 704 include disposition of elements to satisfy the timing constraints generated in the courses from the first and second external-signal receiving circuits 601 and 602 to the internal-signal transmitting and receiving circuit 102 and from the internal-signal transmitting and receiving circuit 102 to the internal circuit 151. Since the disposition steps to satisfy the timing constraints related to the first and second external data terminals 606 and 607 and the first and second external clock terminals 608 and 609 and the disposition steps to satisfy the timing constraints not related to these terminals are separately provided as the disposition steps to satisfy the timing constraints of the semiconductor integrated circuit, this embodiment is effective for realizing a layout that easily satisfies the timing constraints between AC clock signals and AC data signals.

### INDUSTRIAL APPLICABILITY

The semiconductor integrated circuit and the layout method thereof according to the present invention has an effect of realizing a layout that has shorter distances between the external-signal receiving circuit and the external data terminal and between the external-signal receiving circuit and the external clock terminal in order to easily satisfy the timing constraints between AC clock signals and AC data signals without affected by the timing constraint in relation to the internal circuit, and thus they are useful, for example, as a semiconductor integrated circuit including a circuit to externally input an AC clock signal and an AC data signal.

1. A semiconductor integrated circuit including a circuit to which an AC clock signal and an AC data signal are externally inputted, the semiconductor integrated circuit comprising:
an external-signal receiving circuit for receiving the AC data signal inputted from outside of the semiconductor integrated circuit;
an internal-signal transmitting and receiving circuit for receiving a signal generated in an internal circuit of the semiconductor integrated circuit and/or transmitting a signal to the internal circuit;
a data signal wiring for transmitting an output signal of the external-signal receiving circuit to an input signal of the internal-signal transmitting and receiving circuit; and
an AC clock signal wiring for providing the AC clock signal inputted from outside of the semiconductor integrated circuit for the external-signal receiving circuit and the internal-signal transmitting and receiving circuit.

2. The semiconductor integrated circuit according to claim 1, wherein
the external-signal receiving circuit includes an external-signal receiving flip flop for receiving the AC data signal inputted from outside of the semiconductor integrated circuit,
the external-signal receiving flip flop latches the AC data signal and transmits the latched signal via the data signal wiring to the internal-signal transmitting and receiving circuit, and
the AC clock signal inputted from outside of the semiconductor integrated circuit is provided via the AC clock signal wiring for the external-signal receiving flip flop.

3. The semiconductor integrated circuit according to claim 1, wherein
the internal-signal transmitting and receiving circuit includes an internal-signal transmitting and receiving flip flop for receiving the output signal of the external-signal receiving circuit transmitted via the data signal wiring, and
the AC clock signal inputted from outside of the semiconductor integrated circuit is provided for the internal-signal transmitting and receiving flip flop via the AC clock signal wiring.

4. The semiconductor integrated circuit according to claim 2, wherein
the external-signal receiving circuit includes a plurality of the external-signal receiving flip flops, and
the semiconductor integrated circuit comprises a plurality of the data signal wirings.

5. The semiconductor integrated circuit according to claim 3, wherein
the internal-signal transmitting and receiving circuit includes a plurality of the internal-signal transmitting and receiving flip flops, and
the semiconductor integrated circuit comprises a plurality of the data signal wirings.

6. The semiconductor integrated circuit according to claim 2 further comprising a circuit or a circuit element which operates in synchronization with a clock signal instead of the external-signal receiving flip flop.

7. The semiconductor integrated circuit according to claim 3 further comprising a circuit or a circuit element which operates in synchronization with a clock signal instead of the internal-signal transmitting and receiving flip flop.

8. The semiconductor integrated circuit according to claim 1, wherein a clock latency of the AC clock signal wiring connected to the external-signal receiving circuit is shorter than a clock latency of the AC clock signal wiring connected to the internal-signal transmitting and receiving circuit.

9. The semiconductor integrated circuit according to claim 8, wherein
a timing relaxation circuit is interposed in the data signal wiring connecting the output signal of the external-signal receiving circuit and
the input signal of the internal-signal transmitting and receiving circuit.

10. The semiconductor integrated circuit according to claim 9, wherein
the timing relaxation circuit is any of a delay buffer, an inversion latch, and an inversion flip flop which cause a timing delay.

11. The semiconductor integrated circuit according to claim 1 further comprising
an external-signal receiving clock selector and an internal-signal transmitting and receiving clock selector capable of selecting any one of a plurality of the AC clock signals, wherein
an output signal of the external-signal receiving clock selector is inputted to the external-signal receiving circuit, and
an output signal of internal-signal transmitting and receiving clock selector is inputted to the internal-signal transmitting and receiving circuit.

12. The semiconductor integrated circuit according to claim 11, wherein
the external-signal receiving clock selector has a function of selecting any one clock signal from an internal clock signal generated inside of the semiconductor integrated circuit and the plurality of AC clock signals to provide for the external-signal receiving circuit, and
the internal-signal transmitting and receiving clock selector has a function of selecting any one clock signal from the internal clock signal and the plurality of AC clock signals to provide for the internal-signal transmitting and receiving circuit.

13. The semiconductor integrated circuit according to claim 1 further comprising:
a plurality of the external-signal receiving circuits; and
an external-signal reception selecting circuit capable of selecting any output signal of the plurality of external-signal receiving circuits,
wherein the output signals of the external-signal reception selecting circuits are inputted to the internal-signal transmitting and receiving circuit.

14. A layout method of the semiconductor integrated circuit according to claim 11, comprising:
an external-signal receiving circuit disposition step for disposing the external-signal receiving circuit in a vicinity of an external data terminal or an external clock terminal of the semiconductor integrated circuit;
an internal-signal transmitting and receiving circuit disposition step for disposing the internal-signal transmitting and receiving circuit at an arbitrary position of the semiconductor integrated circuit;
an external-signal receiving clock circuit disposition step for disposing and wiring the AC clock signal wiring and/or the external-signal receiving clock selector connected between the external clock terminal and the external-signal receiving circuit in the vicinity of the external clock terminal; and
an internal-signal transmitting and receiving clock circuit disposition step for disposing and wiring the AC clock signal wiring and/or the internal-signal transmitting and receiving clock selector connected between the external clock terminal and the internal-signal transmitting and receiving circuit.
